(19) United States
(12) Patent Application Publication
(10) Pub. No.: US 2025/0331507 A1
(43) Pub. Date: Oct. 30, 2025

(54) AUTONOMOUS FILLING SYNCHRONIZATION FOR MOVING AGRICULTURAL SPRAYERS

(71) Applicant: Jared Ernest Kocer, Sioux Falls, SD (US)

(72) Inventor: Jared Ernest Kocer, Sioux Falls, SD (US)

(21) Appl. No.: 19/194,315

(22) Filed: Apr. 30, 2025

Related U.S. Application Data
(60) Provisional application No. 63/640,505, filed on Apr. 30, 2024.

(51) Int. Cl. A01M 7/00

(52) U.S. Cl. CPC A01M 7/0089; A01M 7/0042; A01M 7/0085

(57) ABSTRACT

A fill synchronization system and method for synchronizing an agricultural sprayer and an autonomous fill machine to supply agricultural product to the agricultural sprayer, while both the agricultural sprayer and the autonomous fill machine are moving. In some situations, this filling operation occurs in an agricultural field while the agricultural sprayer is conducting spraying operations. Synchronizing includes driving the autonomous fill machine to the agricultural sprayer and one or more of corresponding velocities of the agricultural sprayer and the autonomous fill machine and aligning a portion of the vehicles. The system and method include a docking controller that both aligns and couples docking mechanisms on the autonomous fill machine and the agricultural sprayer such that they are in fluid communication. In some examples, the docking mechanisms includes an articulating arm controlled by the docking controller to guide the docking of the agricultural sprayer and the autonomous fill machine.

PRIORITY APPLICATION

This application claims the benefit of priority to U.S. Provisional Application Ser. No. 63/640,505, filed Apr. 30, 2024, the content of which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota. All Rights Reserved.

### TECHNICAL FIELD

The present disclosure relates to agricultural automation systems and, in some examples, to the synchronization of autonomous filling mechanisms for moving agricultural sprayers.

### BACKGROUND

Agricultural sprayers are devices used to apply various agricultural products to agricultural fields. These agricultural products can include fertilizers, pesticides, fungicides, defoliants, and herbicides, which are either premixed or formed by combining these agricultural additives with carrier fluids such as water. The application process involves distributing these agricultural products to agricultural fields.

### SUMMARY

Agricultural sprayers have one or more reservoirs for storing the agricultural product. These sprayer reservoirs limit the potential range or length of an agricultural spraying operation and prompt refilling of the reservoirs for continued operation. However, refilling operations for the sprayer reservoirs slows spraying operations. For instance, upon exhausting the agricultural product, the driver of an agricultural sprayer either drives to a tender vehicle to resupply or, alternatively, the tender vehicle is brought to the location of the agricultural sprayer to resupply. Either way, the refilling procedure takes time away from spraying operations as the agricultural sprayer and tender vehicle are driven to proximity, operators connect hoses and begin start pumping, hoses are disconnected after refilling. After refilling, the sprayer is ready to resume spraying operation. However, if the agricultural sprayer is driven to the tender vehicle, the agricultural sprayer is driven back to the previous location in the agricultural field and can then resume spraying.

If the agricultural sprayer is autonomous, the filling operation is further complicated because computer code and procedures are developed and implemented to automate the driving of the sprayer to a filling location, conduct transfer of the agricultural mixture to the sprayer reservoir, and drive the sprayer back to the agricultural field to resume spraying operations. Moreover, during these filling operations both the tender vehicle and the agricultural sprayer are stationary. The downtime when the agricultural sprayer is not spraying, vehicles are approaching for refilling or the like extends the length of the spraying operations. Further, the downtime causes a loss in efficiency because of the additional driving of one or more of the agricultural sprayer or tender vehicle to a filling location and the interruption of the spraying operation while refilling. The downtime and inefficiencies are multiplied if the sprayer reservoir needs multiple refills during a spraying operation.

Described herein are example fill synchronization systems and methods for synchronizing an agricultural sprayer and an autonomous fill machine that addresses the problems with previous sprayer and filling (including refilling) systems. The fill synchronization systems supply agricultural product to the agricultural sprayer, while both the agricultural sprayer and the autonomous fill machine are moving. In some examples, this filling operation occurs in an agricultural field while the agricultural sprayer is already conducting spraying operations. As used herein, the term “filling” includes both initial filling with an agricultural product and subsequent refilling of the agricultural product into one or more reservoirs of the agricultural sprayer. Moreover, “filling” includes resupplying the sprayer reservoir with the same agricultural product used previously or a different agricultural product relative to the previous product. The terms “filling” or “fill” do not imply that the transfer of the agricultural product from the autonomous fill machine to the agricultural sprayer will result in a completely full sprayer reservoir of the agricultural sprayer. Here, the terms “filling” or “fill” are used to describe the transfer of the agricultural product from one vehicle to another vehicle, without regard for an amount or certain quantity of agricultural product.

Example fill synchronization systems for filling an agricultural sprayer include an autonomous fill machine containing an agricultural product in a fill tank. The autonomous fill machine includes a steering assembly for guiding the autonomous fill machine, an engine for propelling the autonomous fill machines, and a fill machine electronic control unit (ECU) for autonomously driving the autonomous fill machine to the agricultural sprayer in an agricultural field. In one example, both the agricultural sprayer and the autonomous fill machine are moving in the agricultural field while filling. In another example, speed and direction of the agricultural sprayer and the autonomous fill machine correspond while filling. The term “correspond” includes situations where speed and direction of both vehicles align in a manner that some relative motion can be conducted (such as in a turn or because of field variations) while the speed and direct remain proximate to each other, such as within a few miles per hour and a few degrees.

Fill synchronization systems described herein include one or more coupling systems to both align and couple the autonomous fill machine to the agricultural sprayer (including components thereof) to permit fluid communication between the autonomous fill machine and the agricultural sprayer. A transfer system conveys the agricultural product from the autonomous fill machine to the agricultural sprayer, while both the autonomous fill machine and the agricultural sprayer are moving, to ensure the agricultural sprayer continues to conduct spraying operation.

Also described herein are example methods of filling an agricultural sprayer including autonomously driving an autonomous fill machine toward the agricultural sprayer. Autonomous driving of the autonomous fill machine toward the sprayer also includes driving both vehicles toward each other and driving the sprayer toward a ready fill machine that itself begins driving upon arrival of the driven sprayer. Autonomous driving of the autonomous fill machine is performed, in one example, while the agricultural sprayer is moving in an agricultural field. Examples of the method include synchronizing the agricultural sprayer and the autonomous fill machine. In some examples, synchronizing includes one or more of corresponding velocities of the agricultural sprayer and the autonomous fill machine and aligning a portion of the vehicles, such as an autonomous fill machine docking mechanism of the autonomous fill machine and an agricultural sprayer docking mechanism of the agricultural sprayer.

Examples of the methods described herein include coupling the autonomous fill machine docking mechanism with the agricultural sprayer docking mechanism. The autonomous fill machine docking mechanism and the agricultural sprayer docking mechanism are in fluid communication when coupled. An agricultural product is transferred from the autonomous fill machine to the agricultural sprayer across the autonomous fill machine docking mechanism and the agricultural sprayer docking mechanism, while both the autonomous fill machine and the agricultural sprayer are moving. The interconnection fills the sprayer reservoir of the agricultural sprayer with the agricultural product and permits continued spraying operation of the agricultural sprayer.

Disclosed herein is a non-transitory computer-readable storage medium that also includes instructions. The instructions, when executed by a computer, cause the computer to perform operations for synchronizing the filling of an agricultural sprayer with agricultural product. These operations includes autonomously driving the autonomous fill machine to the agricultural sprayer in an agricultural field. This occurs while both the autonomous fill machine and the agricultural sprayer are moving in the agricultural field. These operations also include aligning a fill docking mechanism on the autonomous fill machine to an agricultural sprayer docking mechanism on the agricultural sprayer while both the autonomous fill machine and the agricultural sprayer are moving in the agricultural field and coupling the fill docking mechanism and the agricultural sprayer docking mechanism to be in fluid communication. Moreover, the operations include transferring the agricultural product from the autonomous fill machine to the agricultural sprayer, while both the autonomous fill machine and the agricultural sprayer are moving in the agricultural field, to fill the agricultural sprayer with the agricultural product.

Examples of the instructions also include docking an autonomous fill machine docking mechanism on the autonomous fill machine to an agricultural sprayer docking mechanism on the agricultural sprayer while the autonomous fill machine is moving in the agricultural field and the agricultural sprayer is moving in the agricultural field. Once docked, the instructions couple the autonomous fill machine docking mechanism to the agricultural sprayer docking mechanism so that the autonomous fill machine docking mechanism and the agricultural sprayer mechanism are in fluid communication. The instructions then transfer the agricultural product from the autonomous fill machine to the agricultural sprayer, while both the autonomous fill machine and the agricultural sprayer are moving in the agricultural field. This serves to fill the agricultural sprayer with the agricultural product.

In some examples, one or more of the fill docking mechanism and the agricultural sprayer docking mechanism includes an articulating arm. The articulating arm helps to guide one or more of the fill docking mechanism and the agricultural sprayer docking mechanism such that the two are engaged or couples to each other and in fluid communication. The articulating arm means that the agricultural sprayer and the autonomous fill machine do not have to be perfectly aligned to be able to transfer the agricultural product.

The fill synchronization system and method alleviates stopping the agricultural sprayer during spraying operations in an agricultural field to fill the sprayer reservoir with agricultural product. In some examples, there is virtually no downtime for the agricultural sprayer because it remains in motion while the filling operations occur. Moreover, in some examples, the agricultural sprayer continues spraying the agricultural field while at least some (in some examples, all) of the filling operation is conducted. In some examples, the autonomous fill machine approaches the agricultural sprayer while the agricultural sprayer is moving in the agricultural field, synchronizes, and docks with the agricultural sprayer, and fills the sprayer reservoir of the agricultural sprayer, while both the agricultural sprayer and the autonomous fill machine are moving. These systems and methods thereby mitigate lost time from spraying operations.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates a perspective view of an agricultural sprayer with an agricultural sprayer docking mechanism of an example fill synchronization system.

FIG. 2 illustrates a perspective view of an autonomous fill machine with an autonomous fill machine docking mechanism of an example fill synchronization system.

FIG. 3A illustrates first examples of a plug and socket arrangement that facilitates fluid communication between an agricultural sprayer and an autonomous fill machine.

FIG. 3B illustrates second examples of a plug and socket arrangement having a V-shape that facilitates fluid communication between an agricultural sprayer and an autonomous fill machine.

FIG. 4 illustrates examples of a basket and plug (or probe) arrangement that docks and facilitates fluid communication between an agricultural sprayer and an autonomous fill machine.

FIG. 5 illustrates examples of a locking mechanism in an open or unlocked position that that docks and facilitates fluid communication between an agricultural sprayer and an autonomous fill machine.

FIG. 6 illustrates examples of FIG. 5 with the locking mechanism in a closed or locked position.

FIG. 7 illustrates examples of the autonomous fill machine ready to perform docking and filling operations with the agricultural sprayer in the agricultural field.

FIG. 8 illustrates examples of a filling operation between the agricultural sprayer and the autonomous fill machine in the agricultural field.

FIG. 9 illustrates examples of the agricultural sprayer and the autonomous fill machine docking in the agricultural field.

FIG. 10 is a perspective view of examples of a tender vehicle for resupplying the autonomous fill machine.

FIG. 11 illustrates examples of a stationary tank for resupplying the autonomous fill machine.

FIG. 12 illustrates a block diagram of an example machine configured to conduct one or more of the methods discussed herein.

### DETAILED DESCRIPTION

The efficient application of agricultural products plays a role in maximizing crop yield and maintaining sustainable farming operations. Agricultural sprayers are commonly used to distribute these products across agricultural fields. However, the process of refilling these sprayers can be challenging, particularly in large-scale operations. Traditionally, refilling requires the sprayer to be navigated to a stationary tender vehicle or vice versa, resulting in downtime and reduced operational efficiency. This interruption in spraying operations can lead to delays and increased labor costs, as well as potential inconsistencies in product application.

Existing solutions often involve stationary refilling processes or systems where the tender vehicle is manually connected to the sprayer. These methods are labor-intensive and time-consuming, as they require the sprayer to halt operations for the duration of the refilling process. Additionally, the need for precise alignment between the sprayer and the tender vehicle can be cumbersome, particularly in uneven or challenging terrain. Some systems attempt to automate parts of the process, but they either rely on manual intervention or lack the capability to refill while both vehicles are in motion, limiting their effectiveness in large-scale agricultural settings.

Examples of the autonomous fill synchronization systems and methods discussed herein present approaches for synchronizing an agricultural sprayer with an autonomous fill machine, facilitating on-the-go refilling while both vehicles are in motion. This eliminates the need for the sprayer to stop during refilling, significantly reducing downtime and enhancing operational efficiency. Examples of the systems employs advanced coupling mechanisms, such as V-shaped or laser-guided couplers, to ensure precise alignment and fluid transfer between the vehicles. By utilizing real-time kinematic (RTK) positioning or GPS, these examples provide high-resolution navigation and synchronization, allowing for seamless coordination between the sprayer and the tender vehicle. Additionally, some examples include a flexible docking mechanism that accommodates slight misalignments between the agricultural sprayer and the autonomous fill machine. This not only improves the efficiency of spraying operations but also lessen adverse environmental impact by reducing product spillage and exposure.

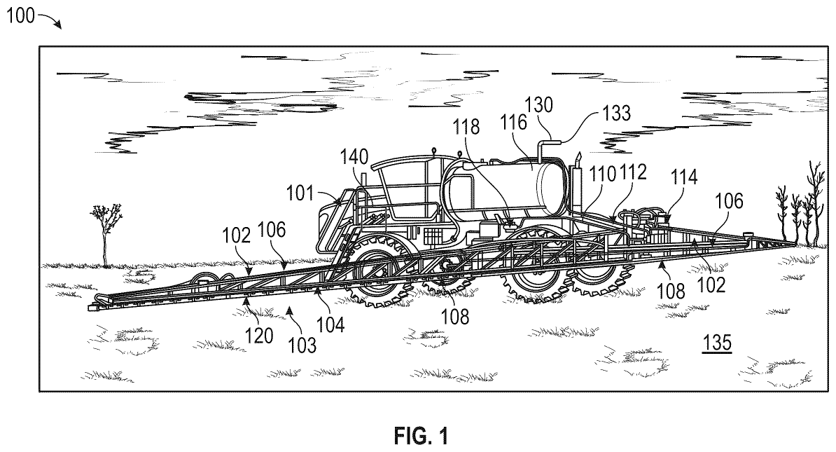

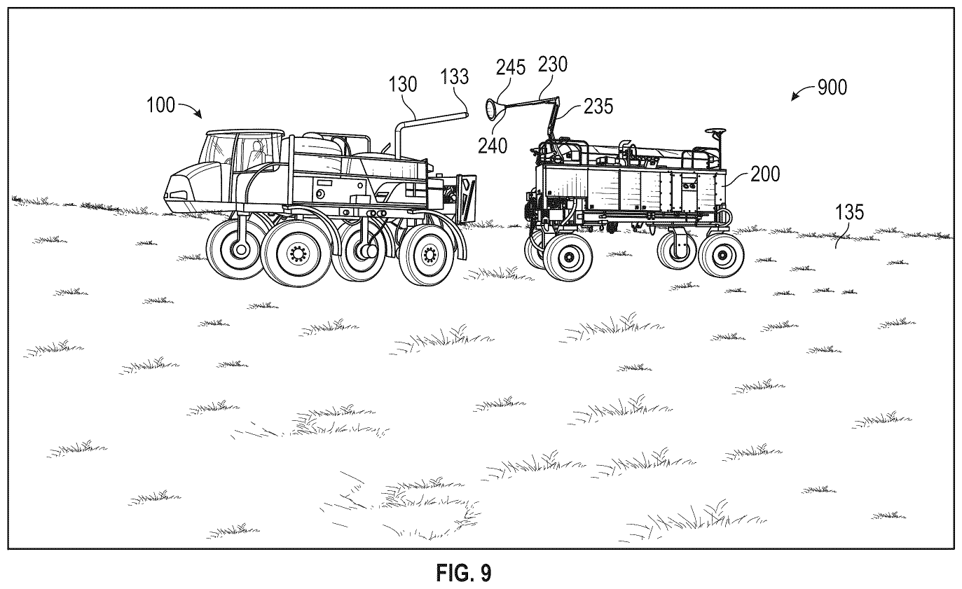

FIG. 1 illustrates a perspective view of one example of an agricultural sprayer 100 with an agricultural sprayer docking mechanism of a fill synchronization system 900 (see FIG. 9). The agricultural sprayer 100 includes a chassis 101 that carries a sprayer reservoir 116 of an agricultural product including a carrier fluid (like a solvent such as water) and a mixed agricultural additive, which can be either powdered or liquid. The mixed agricultural product includes, but is not limited to, fertilizers, herbicides, pesticides, fungicides, defoliants, and the like.

The agricultural sprayer 100 includes a spraying system 103 extending from the sprayer reservoir 116 to one or more product dispensers 120 along sprayer booms 102. The sprayer booms 102 extend from the chassis 101 and each includes respective ones of the sprayer boom tubes 104. The sprayer reservoir 116 includes one or more reservoirs. The one or more reservoirs contain agricultural products, In another example, the one or more reservoirs include a plurality of reservoirs, for instance a carrier fluid reservoir and one or more agricultural additive reservoirs to permit selective mixing of additives with the carrier fluid to provide compositions and concentrations of agricultural products during spraying operations. As further shown in FIG. 1, a system pump 118 is provided along a main line 110 extending from the sprayer reservoir 116. The main line 110 is in communication with the sprayer boom tubes 104. Operation of the system pump 118 delivers the agricultural product from the sprayer reservoir 116 to the sprayer boom tubes 104 for delivery through one or more product dispensers 120. The product dispensers 120 include, but are not limited to, one or more nozzles, arrays of nozzles, boom sections or the like. As further shown in FIG. 1, the sprayer boom tubes 104 include the proximal portions 106 and the distal portions 108. For example, the proximal portions 106 extend along the sprayer booms 102 toward the respective ends of the sprayer booms 102 remote from the chassis 101. The distal portions 108 of the sprayer boom tubes 104 extend from the ends of the sprayer booms 102 toward the chassis 101. In this example, the product dispensers 120 are provided along the distal portions 108. Optionally, the proximal portions 106 and the distal portions 108 are in communication, for instance to permit circulation of the agricultural product to enhance mixing and decrease stagnation or settling.

A control valve 114 (such as a three-way control valve, array of valves or the like) is interposed between the main line 110 and the sprayer boom tubes 104. Moreover, a return line 112 is configured to deliver the pumped agricultural product from the sprayer reservoir 116 to at least one of the sprayer boom tubes 104 (such as the proximal portions 106 of the right one of the sprayer boom tubes 104). In the view shown in FIG. 1, the main line 110 is also in communication with the left one of the sprayer boom tubes 104 (optionally having its respective ones of the proximal portions 106 and the distal portions 108). The agricultural product is delivered from the sprayer reservoir 116 by the system pump 118 and to each of the sprayer boom tubes 104 by way of the main line 110 and, in this example, is metered by the control valve 114. The proximal portions 106 of the sprayer boom tubes 104 deliver the agricultural product to the product dispensers 120 for spraying, and the agricultural mixture (e.g., not applied through the product dispensers 120) returns along the distal portions 108 of the sprayer boom tubes 104 for recirculation or potential application through additional product dispensers provided along the distal portions 108.

In some examples, the circulation of fluids other than the agricultural product through the spraying system 103 is specified. For instance, cleaning agents are circulated through the spraying system 103 to remove residue of a first agricultural product and prepare the spraying system 103 for a second agricultural product. Where cleaning is specified the spraying system 103 is reconfigured relative to the spraying operation.

In some examples, the agricultural sprayer 100 is being driven by a human operator.

In other examples, the agricultural sprayer 100 is driven autonomously. In these examples, the agricultural sprayer 100 includes a control module, such as a sprayer vehicle electronic controller unit (ECU) 140 (or other computing devices), to guide the agricultural sprayer 100 to and through the agricultural field 135. The sprayer vehicle ECU 140 is shown in FIG. 1 with a box around it. In some examples, a global position system (GPS) unit provides location data of the agricultural sprayer 100 in the agricultural field 135. In other examples, a real-time kinematic (RTK) positioning system provides the location data of the agricultural sprayer 100 in the agricultural field 135. In some examples, the agricultural sprayer 100 communicates its location to the autonomous fill machine using one or more of the techniques described above.

FIG. 1 also illustrates an agricultural sprayer docking mechanism 130 to facilitate docking with an autonomous fill machine. The agricultural sprayer docking mechanism 130 shown in FIG. 1 is one example of many of the agricultural sprayer docking mechanism 130. Other examples are discussed below. As shown in FIG. 1, this example of the agricultural sprayer docking mechanism 130 has a plug 133 (or probe) that, when docked, allows the transfer of the agricultural product to the sprayer reservoir 116 of the agricultural sprayer 100. Although in FIG. 1 the position of the agricultural sprayer docking mechanism 130 is shown at the rear and top of the sprayer reservoir 116, in other examples the agricultural sprayer docking mechanism 130 is in other locations on the agricultural sprayer 100 (e.g., on a boom, extending from the boom suspension, extending forward from a front location of the sprayer or the like).

Determining the agricultural sprayer 100 needs filling is accomplished with various embodiments. A notification system for instance is in communication with one or more level sensors, flow meters or the like with the agricultural sprayer 100, The notification system alerts the autonomous fill machine that the agricultural sprayer 100 needs (including will need in the future) additional agricultural product. In some cases, this notification is transmitted wirelessly. In some situations, the agricultural sprayer 100 broadcasts a fill level or flow indication and the autonomous fill machine monitors one or more of these characteristics of the agricultural sprayer 100. Based on the characteristic, the autonomous fill machines determines the agricultural sprayer 100 needs filling (e.g., the characteristic reaches a specified threshold) and responds to fill the agricultural sprayer 100. In some examples, the agricultural sprayer 100 monitors the status of the agricultural product (e.g., fill level, volume sprayed or usage with a flow meter, or the like). When the agricultural sprayer 100 determines, based on status achieving a specified threshold, that the agricultural sprayer 100 needs (including will need) filling, the agricultural sprayer 100 calls for the autonomous fill machine.

In still other examples, a spray path plan is consulted to determine or predict a location for filling. The spray path plan is a planned route the agricultural sprayer 100 follows to spray the agricultural field 135. Using this spray path plan, optionally in combination with a flow rate of the agricultural product and fill level of the sprayer reservoir 116, a predicted location for filling is determined. In this example, the autonomous fill machine determines a location in the agricultural field 135 where the agricultural sprayer 100 is predicted to call for (or needs) filling. The autonomous fill machine can then drive toward the location in preparation for a filling operation.

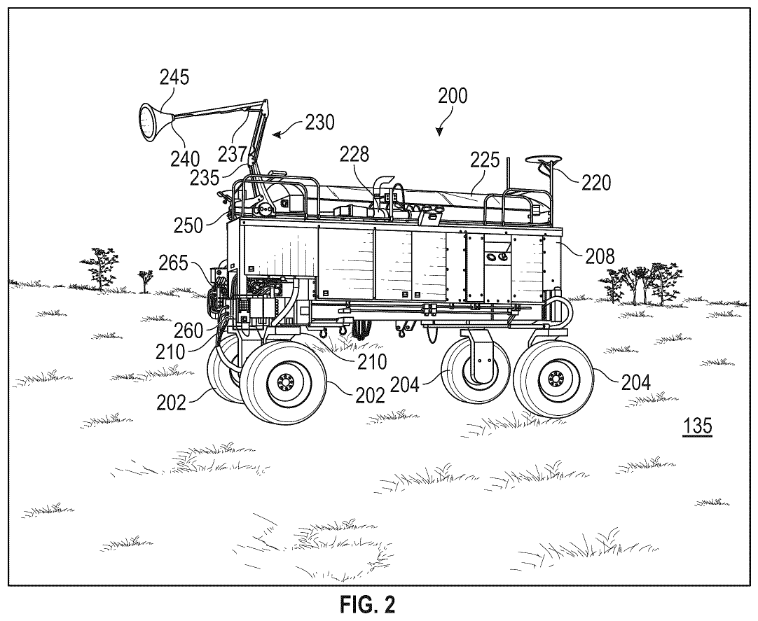

FIG. 2 illustrates a perspective view of examples of an autonomous fill machine 200 with a fill docking mechanism 230 of the fill synchronization system 900. The autonomous fill machine 200 shown in FIG. 2 is one example of a vehicle for filling an agricultural sprayer. In this example, the autonomous fill machine 200 is a modified version of the OMNiPOWER™M 3200 robot, manufactured by Raven Industries. In other examples, the autonomous fill machine 200 includes a tractor and a towed or carried reservoir and a plumbing system. In some examples, more than one of the autonomous fill machine 200 is associated with the agricultural sprayer 100 (e.g., in a field having a spray operation). In other examples, multiple ones of the autonomous fill machine 200 are associated with multiple ones of the agricultural sprayer 100 to conduct filling operations as needed in the field.

As shown in FIG. 2, the autonomous fill machine 200 includes one or more ground engaging elements, such as front wheels 202 and rear wheels 204. The ground engaging elements are attached to a vehicle chassis 208 and can each be configured to actuate or articulate independently relative to the vehicle chassis 208. The front wheels 202 are configured to articulate at one or more angles relative to the vehicle chassis 208. In some examples, a steering assembly 210 is coupled to the front wheels 202.

The autonomous fill machine 200 includes a fill machine electronic controller unit (ECU) 260 (or other computing devices). The fill machine ECU 260 is highlighted in FIG. 2 by a box around it. The fill machine ECU 260 is connected to the steering assembly 210 and an engine 265 guides the autonomous fill machine 200 to and through the agricultural field 135. A navigation antenna 220 allows the autonomous fill machine 200 to both transmit and receive navigational and control information through the fill machine ECU 260. In some examples, a global position system (GPS) unit (e.g., interconnected with the navigation antenna 220) provides location data of the autonomous fill machine 200 in the agricultural field 135. In other examples, a real-time kinematic (RTK) positioning system provides the location data of the autonomous fill machine 200 in the agricultural field 135.

The autonomous fill machine 200 also includes a fill tank 225 for storing a liquid (such as the agricultural product). In addition, the autonomous fill machine 200 also includes a fill pump 228 for pumping the liquid into or out of the fill tank 225. As shown in FIG. 2, the fill docking mechanism 230 is positioned on the autonomous fill machine 200. The fill docking mechanism 230 permits docking with a complementary portion of the agricultural sprayer 100.

The examples of the fill docking mechanism 230 shown in FIG. 2 includes an articulating arm 235 with a flexible hose 237 (e.g., tube, passage in the arm or the like) attached thereon. At an end of the flexible hose 237 is a socket 240. The socket 240 has a complementary profile to interface with the plug 133 of the agricultural sprayer docking mechanism 130. Insertion of the plug 133 and coupling with the socket 240 permits fluid communication between the agricultural sprayer 100 and the autonomous fill machine 200. Also shown in this example is a basket 245 proximate to the socket 240. The basket 245 guides the plug 133 into the socket 240, for instance during movement of both vehicles, and thereby facilitates coupling between the fill docking mechanism 230 and the agricultural sprayer docking mechanism 130. The articulating arm 235 is optionally retractable, and in one example folds adjacent to the autonomous fill machine 200 when not in use.

In one example, the articulating arm 235 is one or more of extendable, retractable, rotatable or the like and is controlled by a docking controller 250 to dock with the agricultural sprayer docking mechanism 130 of the agricultural sprayer 100. In some examples, docking is achieved autonomously. In other examples, the docking is done by remote control (e.g., by an operator on one of the vehicles or by a remote operator). The autonomous fill machine 200 includes the docking controller 250 to control the docking of the fill docking mechanism 230 and the agricultural sprayer docking mechanism 130. The docking controller 250 includes, in one example, a computing device (such as a processor, computer readable medium and processor, or the like) that controls and guides the articulating arm 235 for deployment, coupling and retraction to a stowed configuration.

### Docking

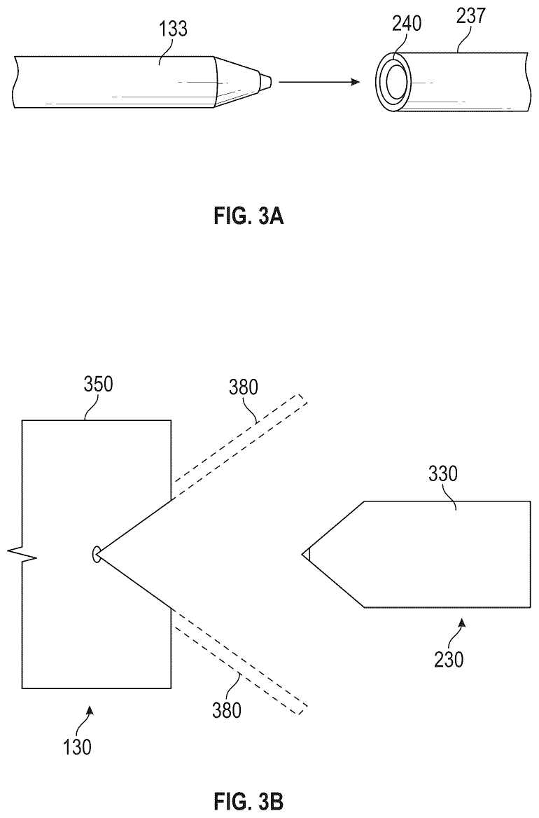

The fill synchronization system 900 includes the agricultural sprayer docking mechanism 130 docking with the fill docking mechanism 230. FIGS. 1 and 2 illustrate one design of the agricultural sprayer docking mechanism 130 and the fill docking mechanism 230. Additional designs are shown in FIGS. 3A, 3B, 4, 5, and 6, and described in detail below. Although these examples can show the agricultural sprayer docking mechanism 130 configured a certain way (such as a plug) and the fill docking mechanism 230 configured a certain way (such as a socket), this does not preclude other examples having reversed roles or variations in shapes (in other words, when the agricultural sprayer docking mechanism 130 is a socket and the fill docking mechanism 230 is a plug, different shapes or the like).

FIG. 3A illustrates first examples of a plug and socket arrangement that facilitates fluid communication between the agricultural sprayer 100 and the autonomous fill machine 200. As shown in FIG. 3A, the plug 133 of the agricultural sprayer docking mechanism 130 fits into the socket 240 of the fill docking mechanism 230 to provide docking between the two. In some examples, a locking mechanism (such as shown in the examples FIG. 5 and described below) locks the coupling of the agricultural sprayer docking mechanism 130 and the fill docking mechanism 230 until decoupling is specified. Typically, decoupling occurs when either the transfer of agricultural product from the autonomous fill machine to the agricultural sprayer is complete or, in some examples, when the agricultural sprayer 100 begins a turn in the agricultural field 135.

FIG. 3B illustrates second examples of a plug and socket arrangement having a V-shaped plug 330 and V-shaped socket 350 that facilitates fluid communication between the agricultural sprayer 100 and the autonomous fill machine 200. In this example the plug and socket arrangement are reversed, such that a V-shaped plug 330 having a closing tapered V-shaped coupling is a component of the fill docking mechanism 230 and fits into the open V-shaped socket 350. The V-shaped socket 350 is an example of the agricultural sprayer docking mechanism 130. In some examples, the V-shaped plug 330 is on a static or articulating arm of the agricultural sprayer 100. In some examples, the V-shaped socket 350 of the agricultural sprayer docking mechanism 130 is on a static or near-static boom extending from the agricultural sprayer 100. As shown in FIG. 3B, some examples of the V-shaped socket 350 include additional ones of the guidance flanges 380. The guidance flanges 380 assist with delivery of the V-shaped plug 330 into the V-shaped socket 350. The dashed lines of the guidance flanges 380 denote that the guidance flanges 380 are present in some examples of the V-shaped socket 350.

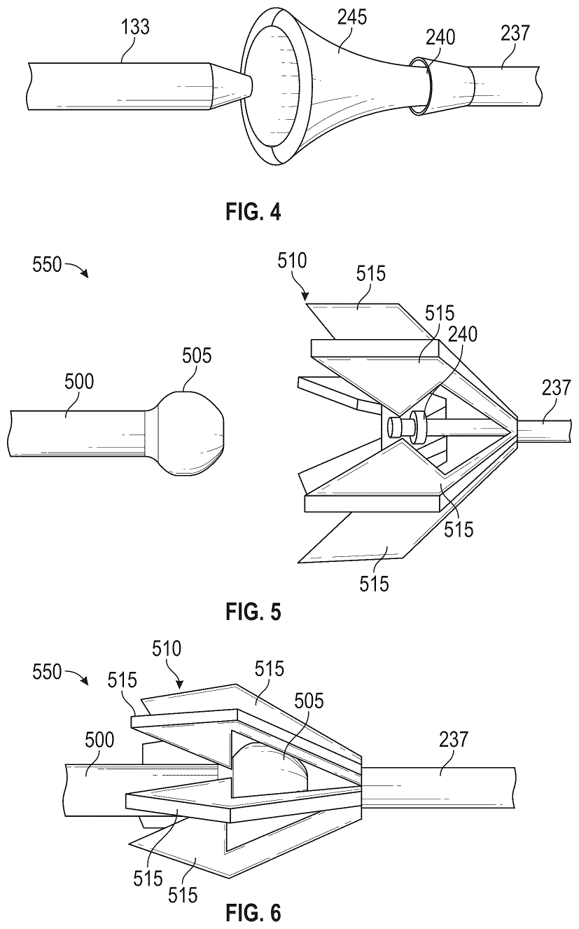

FIG. 4 illustrates examples of a basket and plug (or probe) arrangement that docks and facilitates fluid communication between the agricultural sprayer 100 and the autonomous fill machine 200. Like the plug and socket arrangement of the examples of FIG. 3A, the plug 133 of the agricultural sprayer docking mechanism 130 fits into the socket 240 of the fill docking mechanism 230. The addition of the basket 245 allows the plug 133 to be guided into the socket 240 in a straightforward manner. In some examples, once the plug 133 is engaged with the socket 240, a locking mechanism 550 (such as shown in FIGS. 5 and 6) locks together the agricultural sprayer docking mechanism 130 and the fill docking mechanism 230.

In some examples, docking uses t one or more magnets to guide the plug 133 into the socket 240. In other examples, docking uses a laser mounted on either the fill docking mechanism 230 or the agricultural sprayer docking mechanism 130. Moreover, one or more reflectors is mounted on the other of the fill docking mechanism 230 or the agricultural sprayer docking mechanism 130 to help guide the plug 133 into the socket 240. The docking controller 250 controls this laser-guided docking.

In some examples, the docking uses camera mounted on either the fill docking mechanism 230 or the agricultural sprayer docking mechanism 130. One or more target patterns are mounted on the other of the fill docking mechanism 230 or the agricultural sprayer docking mechanism 130 to cooperatively guide the plug 133 with the camera into the socket 240. Once again, the docking controller 250 controls this camera-guided docking.

In some examples, a locking mechanism 550 (such as shown in the examples of FIG. 5 and described below) secures the coupling of the agricultural sprayer docking mechanism 130 and the fill docking mechanism 230 until decoupling is specified. As noted above, decoupling typically occurs when either the transfer of agricultural product from the autonomous fill machine to the agricultural sprayer 100 is complete or, in some examples, when the agricultural sprayer 100 begins a turn in the agricultural field 135. In other examples, decoupling is initiated if measured force or stress on the agricultural sprayer docking mechanism 130 exceeds one or more thresholds. FIG. 5 illustrates examples of a locking mechanism 550 in an open or unlocked position just prior to docking. In this example, the agricultural sprayer docking mechanism 130 includes a probe 500 and the fill docking mechanism 230 includes a grasper 510. In other examples, the docking mechanisms described in FIG. 3A, 3B, and 4 are included with the agricultural sprayer docking mechanism 130 and the fill docking mechanism 230. For instance, the grasper 510 includes the socket 240 shown in FIGS. 3A and 4 at the end of the flexible hose 237 and attached to the articulating arm 235.

As shown in FIG. 5, the probe 500 includes a knob 505. A liquid, such as an agricultural product, flows through the probe 500 and knob 505 to the flexible hose 237 when coupled. The grasper 510 includes a plurality of prongs 515 located around a socket having a complementary shape to the knob 505. The docking operation includes inserting the probe 500 into the grasper 510. The plurality of prongs 515 close around the knob 505 of the probe 500 to lock the probe 500 and grasper 510 together.

FIG. 6 illustrates examples of the locking mechanism 550 in a closed or locked position. In this locked position, the agricultural sprayer docking mechanism 130 and the fill docking mechanism 230 are docked and in fluid communication. The locking mechanism 550 in the locked position ensures the probe 500 and grasper 510 remain secured to permit flow between the agricultural sprayer 100 and the autonomous fill machine 200.

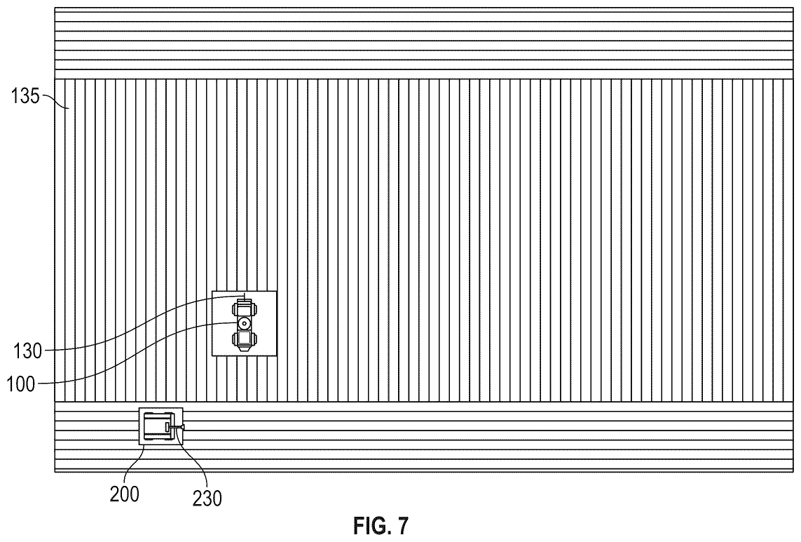

FIG. 7 illustrates examples of the autonomous fill machine 200 ready to perform docking and filling operations with the agricultural sprayer 100 in the agricultural field 135. In the examples of FIG. 7, the agricultural sprayer is in the agricultural field 135 and is moving along crop rows (from top to bottom in FIG. 7). The agricultural sprayer 100 includes the agricultural sprayer docking mechanism 130.

The autonomous fill machine 200 is in or proximate to the agricultural field 135 and ready for the agricultural sprayer 100 to make a turn. The autonomous fill machine 200 includes the fill docking mechanism 230.

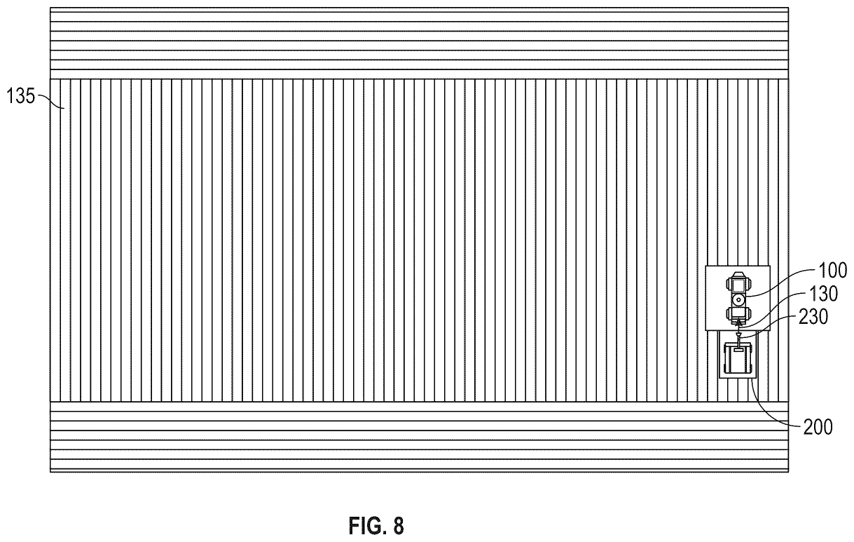

FIG. 8 illustrates examples of a filling operation between the agricultural sprayer 100 and the autonomous fill machine 200 in the agricultural field 135. In this example, the agricultural sprayer 100 has completed a turn in the agricultural field 135 and is moving along a next swatch of crop rows (from bottom to top in FIG. 8). The autonomous fill machine 200 approaches the agricultural sprayer 100 after completion of the agricultural sprayer 100 turn.

With the autonomous fill machine 200 proximate to the agricultural sprayer 100 (e.g., within 5 ft., 10 ft., or the like), the docking controller 250 guides and aligns the fill docking mechanism 230 and the agricultural sprayer docking mechanism 130 and couples the agricultural sprayer docking mechanism 130 and the fill docking mechanism 230 so that they are in fluid communication. Once docked, the agricultural product is transferred from the autonomous fill machine 200 through the fill docking mechanism 230 to the agricultural sprayer docking mechanism 130 and the agricultural sprayer 100.

FIG. 9 illustrates examples of the fill synchronization system 900 with the agricultural sprayer 100 and the autonomous fill machine 200 docking in the agricultural field 135. In the examples shown in FIG. 9, both the agricultural sprayer 100 and the autonomous fill machine 200 are moving from right to left in the agricultural field 135. Moreover, the agricultural sprayer 100 is moving along a swath of one or more crop rows. In some examples, the autonomous fill machine 200 includes ground engaging elements (e.g., tracks, wheels, or the like) that are driven between crop rows like the ground-engaging elements of the agricultural sprayer 100.

In the examples of FIG. 9, the docking controller 250 (see FIG. 2) guides the articulating arm 235 of the fill docking mechanism 230 to dock with the agricultural sprayer docking mechanism 130. For example, the articulating arm 235 is rotated and manipulated (e.g., in one or more of X, Y or Z axes) according to direction from the docking controller 250 (e.g., with an associated camera system, laser system or the like) to place the basket 245 over the plug 133. The docking controller 250 moves the fill docking mechanism 230 through the articulating arm 235 to complete engagement, for instance until the plug 133 is inserted into the socket 240 and optionally secured with a locking mechanism 550 described herein.

### Decoupling

In some examples, decoupling or disengaging the agricultural sprayer docking mechanism 130 from the fill docking mechanism 230 involves arresting coupling between the mechanisms, for instance with relative motion of one or more of the agricultural sprayer 100 or autonomous fill machine 200 that pulls apart the agricultural sprayer docking mechanism 130 and the fill docking mechanism 230. In other examples, as shown in FIGS. 3A, B and 4, the docking controller 250 releases coupling between the agricultural sprayer docking mechanism 130 and the fill docking mechanism 230. For instance, electromagnets are depowered or passive couplings are overcome through pulling by the articulating arm 235. In other examples, such as those examples shown in FIGS. 5 and 6, the docking controller 250 unlocks the locking mechanism 550 by opening the grasper 510 (e.g., with one or more actuators or the like) to move the plurality of prongs 515 away from the knob 505. The agricultural sprayer docking mechanism 130 is permitted to decouple from the fill docking mechanism 230.

The agricultural sprayer docking mechanism 130 and the fill docking mechanism 230 typically remain coupled or docked until the sprayer reservoir 116 is full (including nearly full or a specified fill value) or the fill tank 225 is empty (including nearly empty). In other examples, decoupling involves disengaging the fill docking mechanism 230 and the agricultural sprayer docking mechanism 130 whenever the agricultural sprayer 100 makes a turn in the agricultural field 135.

In still other examples, the agricultural sprayer 100 and autonomous fill machine 200 are driven in tandem along swaths and in turns to permit continued filling during turns. For instance, the articulating arm 235 actuates one or more of the agricultural sprayer docking mechanism 130 and the fill docking mechanism 230 to maintain coupling as the agricultural sprayer 100 and the autonomous fill machine 200 conduct turns. In another example, a hitch is coupled between the agricultural sprayer 100 and the autonomous fill machine 200 that relaxes stress otherwise experienced with the agricultural sprayer docking mechanism 130 and the fill docking mechanism 230.

Decoupling (including disengaging) includes arresting (or ceasing) the transfer of the agricultural product between the agricultural sprayer 100 and the autonomous fill machine 200. In another example, decoupling includes driving the autonomous fill machine 200 away from the agricultural sprayer 100 or driving the agricultural sprayer 100 away from the autonomous fill machine 200. In some examples, both the autonomous fill machine 200 and the agricultural sprayer 100 are driven away from each other.

### Resupplying the Autonomous Fill Machine

In some situations, the fill tank 225 (see FIG. 2) is emptied (including approaching empty) and resupplying of the fill tank 225 is specified. For example, if the autonomous fill machine 200 is filling one or more of the agricultural sprayer 100 (including one of the agricultural sprayer 100 multiple times), the autonomous fill machine 200 could need additional agricultural product to continue filling operations. In another example, the autonomous fill machine 200 fills several different agricultural sprayers, and additional agricultural product is specified to continue filling operations of the agricultural sprayers. In some examples, resupply of the autonomous fill machine 200 is conducted with one or more procedures using one or more of a tender vehicle, a stationary tank, or the like.

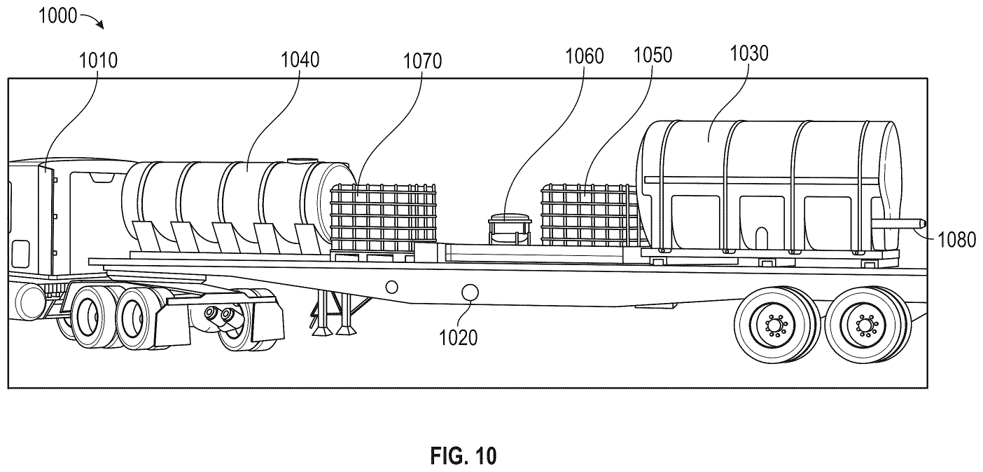

FIG. 10 is a perspective view of examples of a tender vehicle 1000 for resupplying the autonomous fill machine 200. In the examples shown in FIG. 10, the tender vehicle 1000 includes a semi-trailer truck that generally includes a tractor 1010 (or cab) portion and a trailer 1020 portion.

The tender vehicle 1000 includes a primary carrier tank 1030 that stores the agricultural product delivered to the autonomous fill machine 200. The tender vehicle 1000 optionally includes a water tank 1040 and a cleaning agent tank 1050. A chemical tank 1060 is also included and contains a powdered or liquid agricultural additive that, when mixed with a carrier fluid such as water, generates the agricultural product. The tender vehicle 1000 also optionally includes a rinsate tank 1070 for storing the rinse water from a tank cleaning process, for instance when cleaning the plumbing and one or more reservoirs of the agricultural sprayer 100.

A tender vehicle docking mechanism 1080 facilitates the transfer of the agricultural product from the primary carrier tank 1030 on the tender vehicle 1000 to the fill tank 225 of the autonomous fill machine 200. When filling of the autonomous fill machine 200 is specified the autonomous fill machine 200 drives to the tender vehicle 1000. The docking controller 250 docks the fill docking mechanism 230 to the tender vehicle docking mechanism 1080 in a comparable manner to docking with the agricultural sprayer 100. The agricultural product flows through the tender vehicle docking mechanism 1080 (e.g., from one or more of its tanks) through the fill docking mechanism 230 to fill the autonomous fill machine 200 with additional agricultural product.

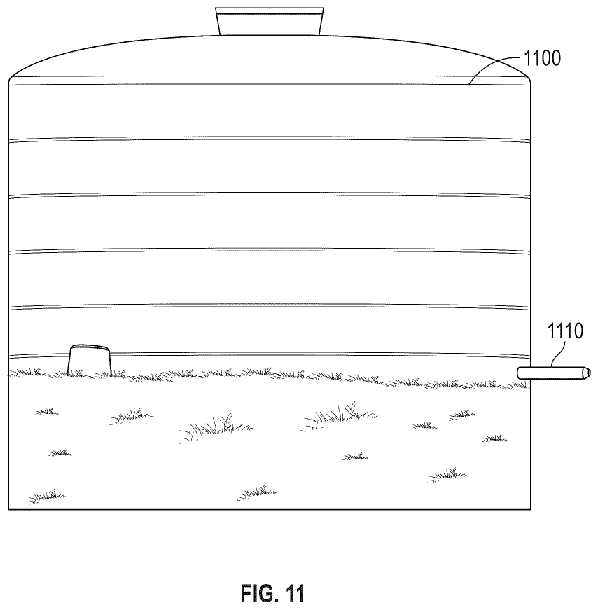

FIG. 11 illustrates examples of a stationary tank 1100 for resupplying the autonomous fill machine 200. The stationary tank 1100 in some examples is a single tank, while in other examples the stationary tank 1100 is one or more tanks. In some examples, the stationary tank 1100 is located near or in the agricultural field 135, but in other examples the stationary tank 1100 is located away from the agricultural field 135. A stationary tank docking mechanism 1110 facilitates the transfer of the agricultural product from the stationary tank 1100 to the fill tank 225 of the autonomous fill machine 200. When filling of the autonomous fill machine 200 is specified the autonomous fill machine 200 drives to the stationary tank 1100. The docking controller 250 docks the fill docking mechanism 230 to the stationary tank docking mechanism 1110 in a comparable manner to docking with the agricultural sprayer 100. The agricultural product flows through the stationary tank docking mechanism 1110 and through the fill docking mechanism 230 to fill the autonomous fill machine 200 with additional agricultural product.

### Additional Notes

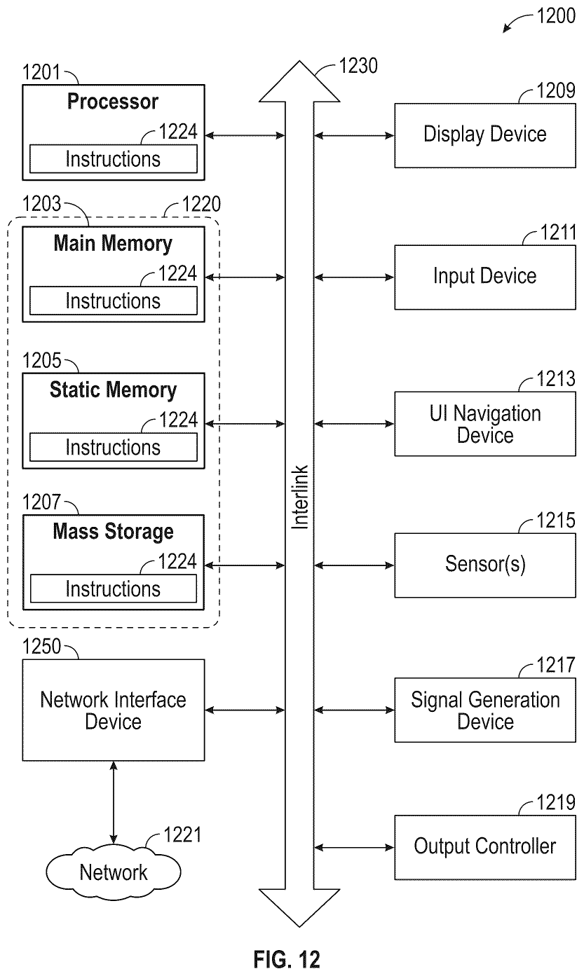

The techniques shown and described in this document can be performed using a portion or an entirety of the fill synchronization system 900 as described above or otherwise using a machine as discussed below in relation to FIG. 12. FIG. 12 illustrates a block diagram of an example comprising a machine 1200 upon which any one or more of the techniques (e.g., methodologies) discussed herein can be performed. In some examples, the machine 1200 can operate as a standalone device or can be connected (e.g., networked) to other machines.

In a networked deployment, the machine 1200 can operate in the capacity of a server machine, a client machine, or both in server-client network environments. In an example, the machine 1200 can act as a peer machine in peer-to-peer (P2P) (or other distributed) network environment. The machine 1200 can be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate by, logic or a number of components, or mechanisms. Circuitry is a collection of circuits implemented in tangible entities that include hardware (e.g., simple circuits, gates, logic, etc.). Circuitry membership can be flexible over time and underlying hardware variability. Circuitries include members that can, alone or in combination, perform specified operations when operating. In an example, hardware of the circuitry can be immutably designed to carry out a specific operation (e.g., hardwired). In an example, the hardware comprising the circuitry can include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent can be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

The machine 1200 (e.g., computer system) can include a hardware-based processor 1201 (e.g., a central processing unit (CPU), a graphics processing unit (GPU), a hardware processor core, plural processors or any combination thereof), a main memory 1203 and a static memory 1205, some or all of which can communicate with each other via an interlink 1230 (e.g., a bus). The machine 1200 including the hardware-based processor 1201 in an example is provided as the docking controller 250. The machine 1200 can further include a display device 1209, an input device 1211 (e.g., an alphanumeric keyboard), and a user interface (UI) navigation device 1213 (e.g., a mouse). In an example, the display device 1209, the input device 1211, and the UI navigation device 1213 can comprise at least portions of a touch screen display. The machine 1200 can additionally include a storage device 1220 (e.g., a drive unit), a signal generation device 1217 (e.g., a speaker), a network interface device 1250, and one or more sensors 1215, such as a real-time kinematic (RTK) positioning, global positioning system (GPS) sensor, compass, accelerometer, camera for observation of one or more of the agricultural sprayer docking mechanism 130 and the fill docking mechanism 230, laser system, or other type of sensor. The machine 1200 can include an output controller 1219, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices, such as the articulating arm 235, locking mechanism 550, fill machine electronic controller unit (ECU) 260, and sprayer vehicle ECU 140.

The storage device 1220 can include a machine-readable medium on which is stored one or more sets of data structures or instructions 1224 (e.g., software or firmware) embodying or utilized by any one or more of the techniques or functions described herein, such as approach of the autonomous fill machine 200 to the agricultural sprayer 100, coupling and decoupling of the agricultural sprayer docking mechanism 130, the fill docking mechanism 230 or the like. The instructions 1224 can also reside, completely or at least partially, within a main memory 1203, within a static memory 1205, within a mass storage device 1207, or within the hardware-based processor 1201 during execution thereof by the machine 1200. In an example, one or any combination of the hardware-based processor 1201, the main memory 1203, the static memory 1205, or the storage device 1220 can constitute machine readable media.

While the machine-readable medium is considered as a single medium, the term “machine-readable medium” can include a single medium or multiple media (e.g., a centralized or distributed database, and/or associated caches and servers) configured to store the instructions 1224.

The term “machine-readable medium” can include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine-readable medium examples can include solid-state memories, and optical and magnetic media. Accordingly, machine-readable media are not transitory propagating signals. Specific examples of massed machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1224 can further be transmitted or received over a communications network 1221 using a transmission medium via the network interface device 1250 utilizing any one of several transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 1250 can include one or more physical jacks (e.g., Ethernet, coaxial, or phone jacks) or one or more antennas to connect to the communications network 1221. In an example, the network interface device 1250 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that can store, encoding or carrying instructions for execution by the machine 1200, and includes digital or analog communications signals or other intangible medium to facilitate communication of such software.

### Various Notes and Aspects

Aspect 1 is a method of filling an agricultural sprayer comprising: autonomously driving an autonomous fill machine toward the agricultural sprayer, wherein autonomously driving includes: the agricultural sprayer is moving in an agricultural field; and the autonomous fill machine is moving in the agricultural field; synchronizing the agricultural sprayer and the autonomous fill machine, wherein synchronizing includes: corresponding velocities of the agricultural sprayer and the autonomous fill machine; and aligning a fill docking mechanism of the autonomous fill machine and an agricultural sprayer docking mechanism of the agricultural sprayer; coupling the fill docking mechanism with the agricultural sprayer docking mechanism, wherein the fill docking mechanism and the agricultural sprayer docking mechanism are in fluid communication; and transferring an agricultural product from the autonomous fill machine to the agricultural sprayer across the fill docking mechanism and the agricultural sprayer docking mechanism, respectively, while both the autonomous fill machine and the agricultural sprayer are moving, to fill a sprayer reservoir of the agricultural sprayer with the agricultural product.

In Aspect 2, the subject matter of Aspect 1 includes, decoupling the fill docking mechanism from the agricultural sprayer docking mechanism, wherein decoupling further comprises: ceasing the transfer of the agricultural product; and autonomously driving one of: (a) the autonomous fill machine away from the agricultural sprayer; (b) the agricultural sprayer away from the autonomous fill machine; or (c) both the autonomous fill machine and the agricultural sprayer away from each other.

In Aspect 3, the subject matter of Aspects 1-2 includes, wherein at least some of the transferring of the agricultural product from the autonomous fill machine to the agricultural sprayer occurs while the agricultural sprayer is spraying the agricultural field.

In Aspect 4, the subject matter of Aspects 1-3 includes, wherein coupling the fill docking mechanism with the agricultural sprayer docking mechanism occurs when the agricultural sprayer is moving in a substantially straight line in the agricultural field, and further comprising decoupling the fill docking mechanism from the agricultural sprayer docking mechanism whenever the agricultural sprayer is turning to change direction in the agricultural field.

In Aspect 5, the subject matter of Aspects 1-4 includes, wherein the fill docking mechanism includes a flexible hose and a basket at one end of the flexible hose and the agricultural sprayer docking mechanism includes a probe, and wherein aligning the fill docking mechanism with the agricultural sprayer docking mechanism further comprises guiding the probe into the basket, and wherein coupling the fill docking mechanism with the agricultural sprayer docking mechanism further comprises inserting the probe into a connector on the basket to allow the fluid communication.

In Aspect 6, the subject matter of Aspects 1-5 includes, wherein the agricultural sprayer communicates its location to the autonomous fill machine using at least one of the following to communicate the location of the agricultural sprayer to the autonomous fill machine: (a) global positioning system (GPS); and (b) real-time kinematic (RTK) positioning.

In Aspect 7, the subject matter of Aspects 1-6 includes, filling the autonomous fill machine by maneuvering the autonomous fill machine to a tender vehicle.

In Aspect 8, the subject matter of Aspects 1-7 includes, filling the autonomous fill machine by maneuvering the autonomous fill machine to a stationary tank.

In Aspect 9, the subject matter of Aspects 1-8 includes, notifying the autonomous fill machine that the agricultural sprayer needs additional agricultural product.

In Aspect 10, the subject matter of Aspect 9 includes, monitoring a flow rate of the agricultural product by the agricultural sprayer and a fill level of the sprayer reservoir; predicting, based on the flow rate and the fill level, that the agricultural sprayer needs filling; and calling for the autonomous fill machine to fill the agricultural sprayer.

In Aspect 11, the subject matter of Aspects 9-10 includes, having the autonomous fill machine monitor a fill level of the sprayer reservoir in the agricultural sprayer; predicting, based on the fill level of the sprayer reservoir, that the agricultural sprayer needs filling; and responding with the autonomous fill machine to fill the agricultural sprayer.

In Aspect 12, the subject matter of Aspects 9-11 includes, consulting a spray path plan, which is a map of a path the agricultural sprayer will follow to spray the agricultural field, to predict a location in the agricultural field where the agricultural sprayer will need filling.

Aspect 13 is a fill synchronization system for filling an agricultural sprayer, comprising: an autonomous fill machine containing an agricultural product, the autonomous fill machine further comprising: a steering assembly for steering the autonomous fill machine; an engine to provide propulsion for the autonomous fill machine; an electronic control unit in communication with the steering assembly and the engine for autonomous driving the autonomous fill machine, such as driving the autonomous fill machine to the agricultural sprayer in an agricultural field, wherein both the agricultural sprayer and the autonomous fill machine are moving in the agricultural field, wherein a speed and a direction of the agricultural sprayer are both correspond to the autonomous fill machine; a fill docking mechanism on the autonomous fill machine; and an agricultural sprayer docking mechanism on the agricultural sprayer that couples to the fill docking mechanism such that the autonomous fill machine and the agricultural sprayer are in fluid communication; wherein the agricultural product transfers from the autonomous fill machine, through the fill docking mechanism, through the agricultural sprayer docking mechanism, and to the agricultural sprayer, while both the autonomous fill machine and the agricultural sprayer are moving, to provide the agricultural sprayer with the agricultural product.

In Aspect 14, the subject matter of Aspect 13 includes, wherein the coupling system further comprises a docking system having the autonomous fill machine docking mechanism on the autonomous fill machine and the agricultural sprayer docking mechanism on the agricultural sprayer such that the autonomous fill machine docking mechanism and the agricultural sprayer docking mechanism are in fluid communication to allow the transfer of the agricultural product from the autonomous fill machine to the agricultural sprayer.

In Aspect 15, the subject matter of Aspect 14 includes, wherein the fill docking mechanism is a socket and the agricultural sprayer docking mechanism is a plug such that the plug inserts into the socket, and wherein one or more of the fill docking mechanism and the agricultural sprayer docking mechanism uses one or more magnets to guide the plug into the socket.

In Aspect 16, the subject matter of Aspects 14-15 includes, wherein the fill docking mechanism is a socket and the agricultural sprayer docking mechanism is a plug such that the plug inserts into the socket, and wherein the fill docking mechanism further comprises a basket such that the plug is guided into the socket by the basket and the plug and socket engage, and wherein the fill docking mechanism further comprises a supply hose supported by an articulating arm, and wherein the basket is attached to an end of the supply hose, and wherein a docking controller controls the articulating arm to guide the plug into the basket.

In Aspect 17, the subject matter of Aspects 14-16 includes, wherein the fill docking mechanism is a socket and the agricultural sprayer docking mechanism is a plug such that the plug inserts into the socket, wherein one or more of the fill docking mechanism and the agricultural sprayer docking mechanism is a laser-guided docking system having a laser mounted on either the fill docking mechanism or the agricultural sprayer docking mechanism and a reflector mounted on the other of the fill docking mechanism or the agricultural sprayer docking mechanism to guide the plug into the socket.

In Aspect 18, the subject matter of Aspects 14-17 includes, wherein the fill docking mechanism is a socket and the agricultural sprayer docking mechanism is a plug such that the plug inserts into the socket, and wherein one or more of the fill docking mechanism and the agricultural sprayer docking mechanism is a camera-guided docking system having a camera mounted on either the fill docking mechanism or the agricultural sprayer docking mechanism and a target pattern mounted on the other of the fill docking mechanism or the agricultural sprayer docking mechanism to guide the plug into the socket.

In Aspect 19, the subject matter of Aspects 14-18 includes, a decoupling system that disengages the autonomous fill machine from the agricultural sprayer by decoupling the fill docking mechanism and the agricultural sprayer docking mechanism, and wherein the decoupling system disengages the fill docking mechanism and the agricultural sprayer docking mechanism whenever the agricultural sprayer makes a turn in the agricultural field.

Aspect 20 is a non-transitory computer-readable storage medium storing instructions that, when executed by a computer, cause the computer to perform operations for synchronizing the filling of an agricultural sprayer with agricultural product, the operations comprising: autonomously driving an autonomous fill machine to the agricultural sprayer in an agricultural field, wherein the autonomous fill machine is moving in the agricultural field and the agricultural sprayer is moving in the agricultural field; aligning a fill docking mechanism on the autonomous fill machine to an agricultural sprayer docking mechanism on the agricultural sprayer while both the autonomous fill machine and the agricultural sprayer are moving in the agricultural field; coupling the fill docking mechanism and the agricultural sprayer docking mechanism to be in fluid communication; and transferring the agricultural product from the autonomous fill machine to the agricultural sprayer, while both the autonomous fill machine and the agricultural sprayer are moving in the agricultural field, to fill the agricultural sprayer with the agricultural product.

Aspect 21 is at least one machine-readable medium including instructions that, when executed by processing circuitry, cause the processing circuitry to perform operations to implement of any of Aspects 1-20.

Aspect 22 is an apparatus comprising means to implement of any of Aspects 1-20.

Aspect 23 is a system to implement of any of Aspects 1-20.

Aspect 24 is a method to implement of any of Aspects 1-20.

In Aspect 25, the subject matter of Aspect 1 includes, decoupling the fill docking mechanism from the agricultural sprayer docking mechanism.

In Aspect 26, the subject matter of Aspect 25 includes, wherein decoupling further comprises: ceasing the transfer of the agricultural product; and autonomously driving one of: (a) the autonomous fill machine away from the agricultural sprayer; (b) the agricultural sprayer away from the autonomous fill machine; or (c) both the autonomous fill machine and the agricultural sprayer away from each other.

In Aspect 27, the subject matter of Aspects 1, 25, and 26 includes, wherein at least some of the transferring of the agricultural product from the autonomous fill machine to the agricultural sprayer occurs while the agricultural sprayer is spraying the agricultural field.

In Aspect 28, the subject matter of Aspects 1 and 25-27 includes, wherein coupling the fill docking mechanism with the agricultural sprayer docking mechanism occurs when the agricultural sprayer is moving in a substantially straight line in the agricultural field.

In Aspect 29, the subject matter of Aspect 28 includes, decoupling the fill docking mechanism from the agricultural sprayer docking mechanism whenever the agricultural sprayer is turning to change direction in the agricultural field.

In Aspect 30, the subject matter of Aspects 1 and 25-29 includes, wherein matching corresponding velocities further comprises having a speed and a direction of the autonomous fill machine and a speed and a direction of the agricultural sprayer be substantially similar.

In Aspect 31, the subject matter of Aspects 1 and 25-30 includes, wherein the fill docking mechanism includes a flexible hose and a basket at one end of the flexible hose and the agricultural sprayer docking mechanism includes a probe.

In Aspect 32, the subject matter of Aspect 31 includes, wherein aligning the fill docking mechanism with the agricultural sprayer docking mechanism further comprises guiding the probe into the basket, and wherein coupling the fill docking mechanism with the agricultural sprayer docking mechanism further comprises inserting the probe into a connector on the basket to allow the fluid communication.

In Aspect 33, the subject matter of Aspects 1 and 25-32 includes, wherein the agricultural sprayer is being driven by a human operator.

In Aspect 34, the subject matter of Aspects 1 and 25-33 includes, wherein the agricultural sprayer is driven autonomously.

In Aspect 35, the subject matter of Aspects 1 and 25-11 includes, wherein the agricultural sprayer communicates its location to the autonomous fill machine.

In Aspect 36, the subject matter of Aspect 35 includes, wherein the global positioning system (GPS) is used to communicate the location of the agricultural sprayer to the autonomous fill machine.

In Aspect 37, the subject matter of Aspects 35-36 includes, wherein real-time kinematic (RTK) positioning is used to communicate the location of the agricultural sprayer to the autonomous fill machine.

In Aspect 38, the subject matter of Aspects 1 and 25-37 includes, filling the autonomous fill machine by maneuvering the autonomous fill machine to a tender vehicle.

In Aspect 39, the subject matter of Aspects 1 and 25-38 includes, filling the autonomous fill machine by maneuvering the autonomous fill machine to a stationary tank.

In Aspect 40, the subject matter of Aspects 1 and 25-39 includes, notifying the autonomous fill machine that the agricultural sprayer needs additional agricultural product.

In Aspect 41, the subject matter of Aspect 40 includes, monitoring a flow rate usage of the agricultural product by the agricultural sprayer and a fill level of the sprayer reservoir; predicting, based on the flow rate and the fill level, usage of the agricultural sprayer, that the agricultural sprayer needs filling; and calling for the autonomous fill machine to fill the agricultural sprayer.

In Aspect 42, the subject matter of Aspects 40-41 includes, having the autonomous fill machine monitor a fill level of the sprayer reservoir in the agricultural sprayer; predicting, based on the fill level of the sprayer reservoir, that the agricultural sprayer needs filling; and responding with the autonomous fill machine to fill the agricultural sprayer.

In Aspect 43, the subject matter of Aspects 40-42 includes, consulting a spray path plan, which is a map of a path the agricultural sprayer will follow to spray the agricultural field, to predict a location in the agricultural field where the agricultural sprayer will need filling.

In Aspect 44, the subject matter of Aspect 43 includes, wherein the location in the agricultural field is near a beginning of the agricultural sprayer moving in a substantially straight line in the agricultural field.

In Aspect 45, the subject matter of Aspect 14 includes, wherein the fill docking mechanism is a socket and the agricultural sprayer docking mechanism is a plug such that the plug inserts into the socket.

In Aspect 46, the subject matter of Aspect 45 includes, wherein one or more of the fill docking mechanism and the agricultural sprayer docking mechanism the docking system uses one or more magnets to guide the plug into the socket.

In Aspect 47, the subject matter of Aspects 45-46 includes, wherein the fill docking mechanism further comprises a basket such that the plug is guided into the socket by the basket and the plug and socket lock when engaged.

In Aspect 48, the subject matter of Aspect 47 includes, wherein the fill docking mechanism further comprises a supply hose supported by an articulating arm, and wherein the basket is attached to an end of the supply hose, and wherein a docking controller controls the articulating arm to guide the plug into the basket.

In Aspect 49, the subject matter of Aspects 45-48 includes, wherein one or more of the fill docking mechanism and the agricultural sprayer docking mechanism is a laser-guided docking system having a laser mounted on either the fill docking mechanism or the agricultural sprayer docking mechanism and a reflector mounted on the other of the fill docking mechanism or the agricultural sprayer docking mechanism to guide the plug into the socket.

In Aspect 50, the subject matter of Aspects 45-49 includes, wherein one or more of the fill docking mechanism and the agricultural sprayer docking mechanism is a camera-guided docking system having a camera mounted on either the fill docking mechanism or the agricultural sprayer docking mechanism and a target pattern mounted on the other of the fill docking mechanism or the agricultural sprayer docking mechanism to guide the plug into the socket.

In Aspect 51, the subject matter of Aspects 14 and 45-50 includes a decoupling system that disengages the autonomous fill machine from the agricultural sprayer by decoupling the fill docking mechanism and the agricultural sprayer docking mechanism.

In Aspect 52, the subject matter of Aspect 51 includes, wherein the decoupling system disengages the fill docking mechanism and the agricultural sprayer docking mechanism whenever the agricultural sprayer makes a turn in the agricultural field.

In Aspect 53, the subject matter of Aspects 13, 14, and 45-52 includes a notification system for wirelessly notifying the autonomous fill machine that the agricultural sprayer needs additional agricultural product.

In Aspect 54, the subject matter of Aspects 13, 14, and 45-53 includes a navigation system for communicating a position of the agricultural sprayer in the agricultural field to the autonomous fill machine.

In Aspect 55, the subject matter of Aspect 54 includes, wherein the navigation system uses real-time kinematic (RTK) positioning.

In Aspect 56, the subject matter of Aspects 54-55 includes, wherein the navigation system uses a global positioning system (GPS).

In Aspect 57, the subject matter of Aspect 20 includes, wherein the coupling of the fill docking mechanism and the agricultural sprayer docking mechanism occurs while the agricultural sprayer is traveling in substantially straight line in the agricultural field.

In Aspect 58, the subject matter of Aspect 57 includes, ceasing the transfer of agricultural product and decoupling the autonomous fill machine docking mechanism and the agricultural sprayer docking mechanism before the agricultural sprayer enters a turn in the agricultural field.

In Aspect 59, the subject matter of Aspects 20 and 57-58 includes, wherein the fill docking mechanism comprises a flexible hose with a socket on one end, and wherein the flexible hose is attached to an articulating arm, and wherein the agricultural sprayer docking mechanism comprises a plug such that the plug fits into the socket; and wherein docking the fill docking mechanism and the agricultural sprayer docking mechanism further comprises guiding the plug into the socket using the articulating arm.

In Aspect 60, the subject matter of Aspect 59 includes, using a laser to guide the plug into the socket.

In Aspect 61, the subject matter of Aspects 59-60 includes, using a camara to guide the plug into the socket.

In Aspect 62, the subject matter of Aspects 20 and 57-61 includes, causing the agricultural sprayer to communicate its location in the agricultural field to the autonomous fill machine.

In Aspect 63, the subject matter of Example 62 includes, using a global positioning system (GPS) to communicate the location of the agricultural sprayer to the autonomous fill machine.

In Aspect 64, the subject matter of Aspects 62-63 includes, using real-time kinematic (RTK) positioning to communicate the location of the agricultural sprayer to the autonomous fill machine.

In Aspect 65, the subject matter of Aspects 62-64 includes, autonomously driving the autonomous fill machine to a tender vehicle to fill the autonomous fill machine with additional agricultural product.

In Aspect 66, the subject matter of Aspects 62-65 includes, autonomously driving the autonomous fill machine to a stationary tank to fill the autonomous fill machine with additional agricultural product.

Aspect 67 is at least one machine-readable medium including instructions that, when executed by processing circuitry, cause the processing circuitry to perform operations to implement of any of Aspects 1, 13, 20 and 25-66.

Aspect 68 is an apparatus comprising means to implement of any of Aspects 1, 13, 20 and 25-66.

In Aspect 69 is a system to implement of any of Aspects 1, 13, 20 and 25-66.

Aspect 70 is a method to implement of any of Aspects 1, 13, 20 and 25-66.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the described systems and methods can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

It is to be understood that the steps of the methods described herein are performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein, such as the methods described herein, is implemented in software code or instructions which are tangibly stored on a tangible computer readable medium. The controller loads the software code or instructions via a direct interface with the computer readable medium or via a wired and/or wireless network. Upon loading and executing such software code or instructions by the controller, the controller can perform any of the functionality of the controller described herein, including any steps of the methods described herein.

The term “software code” or “code” used herein refers to any instructions or set of instructions that influence the operation of a computer or controller. They can exist in a computer-executable form, such as machine code, which is the set of instructions and data directly executed by a computer's central processing unit or by a controller, a human-understandable form, such as source code, which can be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that can be executed on the fly with the aid of an interpreter executed by a computer's central processing unit or by a controller.

The above description is intended to be illustrative, and not restrictive. For example, the above-described examples (or one or more aspects thereof) can be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the aspects. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed implementation. Thus, the following aspects are hereby incorporated into the Detailed Description as examples or implementations, with each aspect standing on its own as a separate implementation, and it is contemplated that such implementations can be combined with each other in various combinations or permutations.

What is claimed is:

1. A method of filling an agricultural sprayer comprising:
autonomously driving an autonomous fill machine toward the agricultural sprayer, wherein autonomously driving includes:
the agricultural sprayer is moving in an agricultural field; and
the autonomous fill machine is moving in the agricultural field;
synchronizing the agricultural sprayer and the autonomous fill machine, wherein synchronizing includes:
corresponding velocities of the agricultural sprayer and the autonomous fill machine; and
aligning a fill docking mechanism of the autonomous fill machine and an agricultural sprayer docking mechanism of the agricultural sprayer;
coupling the fill docking mechanism with the agricultural sprayer docking mechanism, wherein the fill docking mechanism and the agricultural sprayer docking mechanism are in fluid communication; and
transferring an agricultural product from the autonomous fill machine to the agricultural sprayer across the fill docking mechanism and the agricultural sprayer docking mechanism, respectively, while both the autonomous fill machine and the agricultural sprayer are moving, to fill a sprayer reservoir of the agricultural sprayer with the agricultural product.

2. The method of claim 1, further comprising decoupling the fill docking mechanism from the agricultural sprayer docking mechanism, wherein decoupling further comprises:
ceasing the transfer of the agricultural product; and
autonomously driving one of: (a) the autonomous fill machine away from the agricultural sprayer; (b) the agricultural sprayer away from the autonomous fill machine; or (c) both the autonomous fill machine and the agricultural sprayer away from each other.

3. The method of claim 1, wherein at least some of the transferring of the agricultural product from the autonomous fill machine to the agricultural sprayer occurs while the agricultural sprayer is spraying the agricultural field.

4. The method of claim 1, wherein coupling the fill docking mechanism with the agricultural sprayer docking mechanism occurs when the agricultural sprayer is moving in a substantially straight line in the agricultural field, and further comprising decoupling the fill docking mechanism from the agricultural sprayer docking mechanism whenever the agricultural sprayer is turning to change direction in the agricultural field.

5. The method claim 1, wherein the fill docking mechanism includes a flexible hose and a basket at one end of the flexible hose and the agricultural sprayer docking mechanism includes a probe, and wherein aligning the fill docking mechanism with the agricultural sprayer docking mechanism further comprises guiding the probe into the basket, and wherein coupling the fill docking mechanism with the agricultural sprayer docking mechanism further comprises inserting the probe into a connector on the basket to allow the fluid communication.

6. The method of claim 1, wherein the agricultural sprayer communicates its location to the autonomous fill machine using at least one of the following to communicate the location of the agricultural sprayer to the autonomous fill machine: (a) global positioning system (GPS); and (b) real-time kinematic (RTK) positioning.

7. The method of claim 1, further comprising filling the autonomous fill machine by maneuvering the autonomous fill machine to a tender vehicle.

8. The method of claim 1, further comprising filling the autonomous fill machine by maneuvering the autonomous fill machine to a stationary tank.

9. The method of claim 1, further comprising notifying the autonomous fill machine that the agricultural sprayer needs additional agricultural product.

10. The method of claim 9, further comprising:
monitoring a flow rate of the agricultural product by the agricultural sprayer and a fill level of the sprayer reservoir;
predicting, based on the flow rate and the fill level, that the agricultural sprayer needs filling; and
calling for the autonomous fill machine to fill the agricultural sprayer.

11. The method of claim 9, further comprising:
having the autonomous fill machine monitor a fill level of the sprayer reservoir in the agricultural sprayer;
predicting, based on the fill level of the sprayer reservoir, that the agricultural sprayer needs filling; and
responding with the autonomous fill machine to fill the agricultural sprayer.

12. The method of claim 9, further comprising consulting a spray path plan, which is a map of a path the agricultural sprayer will follow to spray the agricultural field, to predict a location in the agricultural field where the agricultural sprayer will need filling.

13. A fill synchronization system for filling an agricultural sprayer, comprising:
an autonomous fill machine containing an agricultural product, the autonomous fill machine further comprising:
a steering assembly for steering the autonomous fill machine;
an engine to provide propulsion for the autonomous fill machine;
an electronic control unit in communication with the steering assembly and the engine for autonomous driving the autonomous fill machine, such as driving the autonomous fill machine to the agricultural sprayer in an agricultural field, wherein both the agricultural sprayer and the autonomous fill machine are moving in the agricultural field, wherein a speed and a direction of the agricultural sprayer are both correspond to the autonomous fill machine;
a fill docking mechanism on the autonomous fill machine; and
an agricultural sprayer docking mechanism on the agricultural sprayer that couples to the fill docking mechanism such that the autonomous fill machine and the agricultural sprayer are in fluid communication; wherein the agricultural product transfers from the autonomous fill machine, through the fill docking mechanism, through the agricultural sprayer docking mechanism, and to the agricultural sprayer, while both the autonomous fill machine and the agricultural sprayer are moving, to provide the agricultural sprayer with the agricultural product.

14. The fill synchronization system of claim 13, wherein the coupling system further comprises a docking system having the autonomous fill machine docking mechanism on the autonomous fill machine and the agricultural sprayer docking mechanism on the agricultural sprayer such that the autonomous fill machine docking mechanism and the agricultural sprayer docking mechanism are in fluid communication to allow the transfer of the agricultural product from the autonomous fill machine to the agricultural sprayer.

15. The fill synchronization system of claim 14, wherein the fill docking mechanism is a socket and the agricultural sprayer docking mechanism is a plug such that the plug inserts into the socket, and wherein one or more of the fill docking mechanism and the agricultural sprayer docking mechanism uses one or more magnets to guide the plug into the socket.

16. The fill synchronization system of claim 14, wherein the fill docking mechanism is a socket and the agricultural sprayer docking mechanism is a plug such that the plug inserts into the socket, and wherein the fill docking mechanism further comprises a basket such that the plug is guided into the socket by the basket and the plug and socket engage, and wherein the fill docking mechanism further comprises a supply hose supported by an articulating arm, and wherein the basket is attached to an end of the supply hose, and wherein a docking controller controls the articulating arm to guide the plug into the basket.

17. The fill synchronization system of claim 14, wherein the fill docking mechanism is a socket and the agricultural sprayer docking mechanism is a plug such that the plug inserts into the socket, wherein one or more of the fill docking mechanism and the agricultural sprayer docking mechanism is a laser-guided docking system having a laser mounted on either the fill docking mechanism or the agricultural sprayer docking mechanism and a reflector mounted on the other of the fill docking mechanism or the agricultural sprayer docking mechanism to guide the plug into the socket.

18. The fill synchronization system of claim 14, wherein the fill docking mechanism is a socket and the agricultural sprayer docking mechanism is a plug such that the plug inserts into the socket, and wherein one or more of the fill docking mechanism and the agricultural sprayer docking mechanism is a camera-guided docking system having a camera mounted on either the fill docking mechanism or the agricultural sprayer docking mechanism and a target pattern mounted on the other of the fill docking mechanism or the agricultural sprayer docking mechanism to guide the plug into the socket.

19. The fill synchronization system of claim 14, further comprising a decoupling system that disengages the autonomous fill machine from the agricultural sprayer by decoupling the fill docking mechanism and the agricultural sprayer docking mechanism, and wherein the decoupling system disengages the fill docking mechanism and the agricultural sprayer docking mechanism whenever the agricultural sprayer makes a turn in the agricultural field.

20. A non-transitory computer-readable storage medium storing instructions that, when executed by a computer, cause the computer to perform operations for synchronizing the filling of an agricultural sprayer with agricultural product, the operations comprising:
autonomously driving an autonomous fill machine to the agricultural sprayer in an agricultural field, wherein the autonomous fill machine is moving in the agricultural field and the agricultural sprayer is moving in the agricultural field;
aligning a fill docking mechanism on the autonomous fill machine to an agricultural sprayer docking mechanism on the agricultural sprayer while both the autonomous fill machine and the agricultural sprayer are moving in the agricultural field;
coupling the fill docking mechanism and the agricultural sprayer docking mechanism to be in fluid communication; and
transferring the agricultural product from the autonomous fill machine to the agricultural sprayer, while both the autonomous fill machine and the agricultural sprayer are moving in the agricultural field, to fill the agricultural sprayer with the agricultural product.
